(19) United States
(12) Patent Application Publication
(10) Pub. No.: US 2024/0198260 A1
(43) Pub. Date: Jun. 20, 2024

(54) FLOW PATH ASSEMBLY FOR WATER PURIFIER

(71) Applicant: COWAY Co., Ltd., Gongju-si (KR)

(72) Inventors: Sanggu SIM, Seoul (KR); Sungjin KIM, Seoul (KR); Kyujun KIM, Seoul (KR); Wonil JOO, Seoul (KR); Sang Woo BANG, Seoul (KR); Manuk PARK, Seoul (KR); Chanjung PARK, Seoul (KR)

(73) Assignee: COWAY Co., Ltd., Gongju-si (KR)

(21) Appl. No.: 18/555,820

(22) PCT Filed: Apr. 30, 2021
(86) PCT No.: PCT/KR2021/005520

§ 371 Date: Oct. 17, 2023

(51) Int. Cl. B01D 35/157; B01D 35/153; B01D 35/30

(52) U.S. Cl. CPC B01D 35/1573; B01D 35/153; B01D 35/306

(57) ABSTRACT

The flow path assembly for a water purifier according to an embodiment of the present disclosure may easily mount various parts and filters therein while integrating flow paths which are movement paths of introduced raw water with each other, and may minimize usage of pipes by applying a plurality of flow path parts integrated with each other without a fusion work, and simultaneously have improved workability while shortening the assembly and replacement time of a filter and each part by securing an internal space.

### TECHNICAL FIELD

The present disclosure relates to a flow path assembly for a water purifier, and more particularly, to a flow path assembly for a water purifier which may easily mount various parts and filters therein while integrating flow paths which are movement paths of introduced raw water with each other.

### BACKGROUND ART

In general, a water purifier is a device purifying raw water supplied from a raw water supply source such as a water supply or a water bottle, and is a device supplying purified water to a user by removing impurities such as a heavy metal and another harmful substance contained in raw water through physical or chemical methods such as precipitation, filtration, and sterilization.

This water purifier may have a structure for supplying the user with purified water, which is ultimately purified water, by allowing supplied raw water to sequentially pass through different filtration elements disposed in a filter.

That is, the water purifier according to the prior art may include an inlet hole through which raw water is introduced, an outlet hole through which filtered purified water is discharged, at least one filter for filtering and purifying introduced raw water, a pump for circulating the introduced raw water therein, a plurality of pipes for connecting the respective components with each other by forming a flow path through which raw water flows, or the like.

In addition, various sensors, various parts including various valves, branch pipes, nipples, or the like may be installed between the respective pipes or at a portion where each pipe is connected to the component.

However, the prior water purifier as described above may have a structure in which individual pipes are complicatedly connected to each other to flow raw water to each component. Therefore, each pipe may have a complex layout in a narrow space of the water purifier, and it may be difficult to install each part due to these pipes, which may lower assembly quality.

In addition, the individual pipes complicatedly connected to each other may be connected in various shapes (for example, curved or bent shapes) rather than a straight line, which may result in lower pressure resistance performance. As a result, water leakage or damage to the pipe may occur due to a pressure of raw water passing through the pipe.

In addition, when replacing the filter and an old pipe that require periodic replacements, or replacing a pipe that leaks or is damaged, due to the complex layout of the pipes, it requires excessive amount of time to replace the filter, the part, and the pipe and it is difficult to assemble and disassemble the same, thus lowering overall maintainability.

In addition, it is essentially necessary to perform a sealing work between the respective pipes and the parts to prevent the water leakage, and it is also difficult to meet the pressure resistance performance of the pipes.

Meanwhile, the development of integrated flow path is in progress recently to solve these problems. However, due to the complexity of the flow path, it is impossible to manufacture the integrated flow path by using a single mold, which may increase a production cost.

In addition, when the pipes are separately provided and then fused together, the assembly may have an insufficient bonding strength. Therefore, the leakage or the damage may occur when an internal pressure is increased due to an imbalance in a bonding strength.

In addition, when applying the fusion method to the pipes, a wall thickness may inevitably need to be abnormally increased to increase a fusion strength, which may lower productivity of injection molding, and cause a fusion bur due to excessive fusion to thus block the flow path.

The above information disclosed in this background section is provided only to assist in better understanding of the background of the present disclosure, and may thus include information not included in the prior art already known to those skilled in the art to which the present disclosure pertains.

### DISCLOSURE

### Technical Problem

An embodiment of the present disclosure provides a flow path assembly for a water purifier which may easily mount various parts and filters therein while integrating flow paths which are movement paths of introduced raw water with each other.

Another embodiment of the present disclosure provides a flow path assembly for a water purifier which may minimize usage of pipes by applying a plurality of flow path parts integrated with each other without a fusion work, and simultaneously have improved workability while shortening the assembly and replacement time of a filter and each part by securing an internal space.

Another embodiment of the present disclosure provides a flow path assembly for a water purifier which may prevent leakage or damage due to a pressure of raw water.

### Technical Solution

According to an embodiment of the present disclosure, provided is a flow path assembly for a water purifier, the assembly including: a main body; one or more flow path parts each having a flow path through which raw water or purified water flows therein, and protruding from one surface of the main body for one or more parts to be mounted thereon; and one or more filter mounting parts formed on the other surface of the main body to be opposite to the one or more flow path parts for at least one filter filtering raw water introduced through one flow path part among the one or more flow path parts to be mounted thereon, wherein among the flow paths respectively formed in the one or more flow path parts, the flow paths disposed to correspond to the one or more filter mounting parts pass through the main body to be connected to the one or more filter mounting parts for raw water to be filtered and purified through the at least one filter, and the other flow paths are each selectively connected with each other through the one part mounted on the one or more flow path parts.

The one or more flow path parts may include a first flow path part having a first flow path formed in a vertical direction parallel to the main body based on a length direction of the main body, a second flow path part disposed to be spaced apart from the first flow path part in a width direction of the main body, bent toward a lower part of the main body while protruding by a predetermined length from the main body, and having a second flow path formed therein, a third flow path part disposed at a lower part of the second flow path part, and having a third flow path formed in a direction perpendicular to the second flow path, a fourth flow path part disposed at a lower part of the third flow path part, and having a fourth flow path formed in a direction parallel to the third flow path, and a fifth flow path part disposed on an upper part of the main body that is opposite to the first flow path part based on the width direction of the main body, and having a fifth flow path formed in a vertical direction parallel to the first flow path.

The third flow path part may include a connection part formed on the third flow path part at a position corresponding to the second flow path part for purified water flowing into the second flow path to pass through the third flow path, and connected to the second flow path through the one or more parts, and a bent part having an end disposed to be adjacent to the first flow path part and bent from one surface of the main body toward the outside.

The fourth flow path part may include a protrusion protruding toward the outside from the one surface of the main body to correspond to the bent part to connect the third flow path with the fourth flow path through the one or more parts, and a pump connection part having an end facing the first flow path part and bent toward the lower part of the main body, and connected to a pump through the one or more parts.

The fifth flow path part may have a tank connection part integrated with the fifth flow path part that protrudes in a center of the fifth flow path part based on a length direction of the fifth flow path part in a direction perpendicular to the fifth flow path part to be connected to a flushing tank for purified water stored in the flushing tank to be selectively introduced into the fifth flow path.

The one or more flow path parts may include a sixth flow path part disposed to be spaced apart from the fifth flow path part toward the first flow path part based on the width direction of the main body, and having a sixth flow path formed in a direction parallel to the fifth flow path, a seventh flow path part disposed between the fifth flow path part and the sixth flow path part, and having a seventh flow path formed in a direction parallel to the sixth flow path, an eighth flow path part disposed between the first flow path part and the sixth flow path part, and having an eighth flow path formed in the vertical direction parallel to the first flow path, a ninth flow path part disposed between the first flow path part and the second flow path part to be close to the first flow path part, and having a ninth flow path formed in a direction perpendicular to the first flow path, and a tenth flow path part disposed between the ninth flow path part and the second flow path part based on the width direction of the main body, and having a tenth flow path formed in a direction parallel to the first flow path.

The sixth flow path part may further include a first flow path connection part protruding from a lower part based on a length direction of the sixth flow path part in a direction perpendicular to the sixth flow path part to connect the ninth flow path with the sixth flow path through the one or more parts.

The seventh flow path part may further include a residential water discharge part protruding from an upper part based on a length direction of the seventh flow path part in a direction perpendicular to the seventh flow path part for purified water flowing through the seventh flow path to be discharged as residential water through the one or more parts.

The eighth flow path part may further include a second flow path connection part protruding from a lower part based on a length direction of the eighth flow path part in a direction perpendicular to the eighth flow path part to connect the eighth flow path with the tenth flow path through the one or more parts.

The second flow path part may be bent into an “L” shape to partially surround the outside of the third flow path part.

The first, second, third, fourth, fifth, sixth, seventh, eighth, ninth, and tenth flow paths may be formed in the main body not to communicate with each other, or to be selectively connected with each other through the one or more parts or the one or more filters.

The filter mounting part may include a first filter mounting part formed on a lower part of the other surface of the main body, and a second filter mounting part formed on the other surface of the main body to be spaced upward from the first filter mount.

The first filter mounting part may include a first inlet hole communicating with the first flow path, a first outlet hole communicating with the second flow path, a second inlet hole communicating with the tenth flow path, and a second outlet hole communicating with the ninth flow path.

The first and second inlet holes and the first and second outlet holes may be disposed on the same line in the width direction of the main body.

The first inlet hole and the first outlet hole may respectively be disposed on both sides of the main body based on the width direction of the main body, the second inlet hole may be disposed between the first inlet hole and the first outlet hole to be close to the first outlet hole, and the second outlet hole may be disposed between the first inlet hole and the first outlet hole to be close to the first inlet hole.

The second filter mounting part may include a third inlet hole communicating with the fifth flow path, a third outlet hole communicating with the eighth flow path, and a residential water outlet hole communicating with the seventh flow path.

The third inlet hole, the third outlet hole, and the residential water outlet hole may be disposed on the same line in the width direction of the main body.

According to another embodiment of the present disclosure, provided is a flow path assembly for a water purifier, the assembly including: a first body and a second body configured to be separated from each other to be coupled with each other; one or more flow path parts each having a flow path through which raw water or purified water flows therein, and protruding from one surface or the other surface of each of the first and second bodies for one or more parts to be mounted thereon; and one or more filter mounting parts formed on the other surface of each of the first and second bodies to be opposite to the one or more flow path parts for at least one filter filtering raw water introduced through one flow path part among the one or more flow path parts to be mounted thereon, wherein among the one or more flow path parts, the one or more flow path parts formed at corresponding positions on one surface or the other surface of each of the first body and the second body are connected with each other directly or through the one or more parts in a state where the first body and the second body are coupled with each other, among the flow paths respectively formed in the one or more flow path parts, the flow paths respectively disposed to correspond to the one or more filter mounting parts pass through the first body or the second body to be connected to the one or more filter mounting parts for raw water to be purified water through the at least one filter, and the other flow paths are selectively connected with each other, respectively, through the one or more flow path parts directly connected thereto or through the one or more parts mounted on the one or more flow path parts.

The one or more flow path parts may include a first flow path part formed on the one surface of each of the first and second bodies, and having a first flow path formed in the vertical direction parallel to the first and second bodies along length directions of the first and second bodies, a second flow path part disposed to be spaced apart from the first flow path part in a width direction of the second body, protruding by a predetermined length from the one surface of the second body, and having a second flow path formed therein, a third flow path part disposed at a lower part of the second flow path part on the one surface of the second body, having both ends protruding from the one surface of the second body based on the width direction of the second body, and having a third flow path formed therein, a fourth flow path part disposed at a lower part of a first lower flow path part on the one surface of the second body, and having a fourth flow path formed in a vertical direction parallel to a first lower flow path part, a fifth flow path part formed on the other surface of each of the first and second bodies to be close to the first flow path part based on the width directions of the first and second bodies, and having a fifth flow path formed in a vertical direction parallel to the first flow path, and a sixth flow path part disposed to be spaced apart from and opposite to the first flow path part based on the width direction of the first body, and having a sixth flow path formed in a direction parallel to the fifth flow path.

The one or more flow path parts may further include a seventh flow path part formed on the one surface of each of the first and second bodies to be close to the fifth flow path part based on the width directions of the first and second bodies, and having a seventh flow path formed in the vertical direction parallel to the first flow path, an eighth flow path part formed on the one surface of each of the first and second bodies between the sixth flow path part and the seventh flow path part to be close to the sixth flow path part, and having an eighth flow path formed in the vertical direction parallel to the first flow path, a ninth flow path part formed on the one surface of each of the first and second bodies between the seventh flow path part and the eighth flow path part, and having a ninth flow path formed in the vertical direction parallel to the first flow path, a tenth flow path part disposed at a lower part of the seventh flow path part on one surface of the second body, and having a tenth flow path formed in a direction perpendicular to the first flow path, an eleventh flow path part formed at a position corresponding to the ninth flow path part on the other surface of the second body, and having an eleventh flow path formed in the direction perpendicular to the first flow path, and a twelfth flow path part disposed to be spaced apart from the one surface of the second body to be opposite to the fourth flow path part based on the width direction of the second body, and having a twelfth flow path formed in a vertical direction parallel to the first flow path.

### Advantageous Effects

As set forth above, the flow path assembly for a water purifier according to an embodiment of the present disclosure may easily mount the various parts and filters therein while integrating the flow paths which are the movement paths of introduced raw water with each other.

In addition, the present disclosure may minimize the usage of pipes by applying the plurality of flow path parts integrated with each other without the fusion work, and simultaneously have the improved workability while shortening the assembly and replacement time of the filter and each part by securing the internal space.

In addition, the present disclosure may improve the maintainability by easily assembling and disassembling each component and the various parts, reduce the production cost by reducing the overall number of parts, and improve the productivity.

In addition, the present disclosure may minimize the occurrence of the product defect by improving the airtightness by preventing the leakage or the damage due to the pressure of raw water, and reduce the overall size of the water purifier by promoting the smaller size, thereby improving the overall marketability.

### DESCRIPTION OF THE DRAWINGS

FIG. 1 is a perspective view of a water purifier to which a flow path assembly for a water purifier is applied according to a first embodiment of the present disclosure.

FIG. 2 is a projection perspective view of the water purifier to which the flow path assembly for a water purifier is applied according to the first embodiment of the present disclosure.

FIG. 3 is a rear perspective view of the flow path assembly for a water purifier according to the first embodiment of the present disclosure in which various parts are mounted.

FIG. 4 is a rear view of the flow path assembly for a water purifier according to the first embodiment of the present disclosure in which various parts are mounted.

FIG. 5 is a front perspective view of the flow path assembly for a water purifier according to the first embodiment of the present disclosure.

FIG. 6 is a rear perspective view of the flow path assembly for a water purifier according to the first embodiment of the present disclosure.

FIG. 7 is a front view of the flow path assembly for a water purifier according to the first embodiment of the present disclosure.

FIG. 8 is a rear view of the flow path assembly for a water purifier according to the first embodiment of the present disclosure.

FIG. 9 is a cross-sectional view taken along line A-A of FIG. 8.

FIG. 10 is a cross-sectional view taken along line B-B of FIG. 8.

FIG. 11 is a cross-sectional view taken along line C-C of FIG. 8.

FIG. 12 is a view of a flow in a flow path and shows flows of raw water and purified water in a water purifier to which the flow path assembly for a water purifier according to the first embodiment of the present disclosure is applied.

FIG. 13 is a perspective view of a water purifier to which a flow path assembly for a water purifier according to a second embodiment of the present disclosure is applied.

FIG. 14 is a projection perspective view of the water purifier to which the flow path assembly for a water purifier is applied according to the second embodiment of the present disclosure.

FIG. 15 is a rear perspective view of the flow path assembly for a water purifier in which various parts are mounted according to the second embodiment of the present disclosure.

FIG. 16 is a rear view of the flow path assembly for a water purifier in which various parts are mounted according to the second embodiment of the present disclosure.

FIG. 17 is a front perspective view of the flow path assembly for a water purifier according to the second embodiment of the present disclosure.

FIG. 18 is a rear perspective view of the flow path assembly for a water purifier according to the second embodiment of the present disclosure.

FIG. 19 is an exploded perspective view of the flow path assembly for a water purifier according to the second embodiment of the present disclosure.

FIG. 20 is a front view of the flow path assembly for a water purifier according to the second embodiment of the present disclosure.

FIG. 21 is a rear view of the flow path assembly for a water purifier according to the second embodiment of the present disclosure.

FIG. 22 is a cross-sectional view taken along line X-X of FIG. 21.

FIG. 23 is a cross-sectional view taken along line Y-Y of FIG. 21.

FIG. 24 is a view of a flow in a flow path and shows flows of raw water and purified water in a water purifier to which the flow path assembly for a water purifier according to the second embodiment of the present disclosure is applied.

### MODE FOR INVENTION

Hereinafter, embodiments of the present disclosure are described in detail with reference to the accompanying drawings.

Prior thereto, the configurations described in the embodiments and drawings of the present disclosure are merely most preferable embodiments but do not represent all of the technical spirit of the present disclosure. Therefore, the present disclosure should be construed as including all the changes, equivalents, and substitutions included in the spirit and scope of the present disclosure at the time of filing this application.

A portion unrelated to the description is omitted in order to obviously describe the present disclosure, and the same or similar components are denoted by the same reference numeral throughout the specification.

The size and thickness of each component shown in the accompanying drawings are arbitrarily shown for convenience of explanation, and therefore, the present disclosure is not necessarily limited to contents shown in the accompanying drawings, and the thicknesses are exaggerated in the drawings in order to clearly represent some portions and regions.

In addition, throughout the present specification, unless especially described to the contrary, “including” any components may be understood to imply the inclusion of other elements rather than the exclusion of any other elements.

In addition, terms such as “˜unit”, “˜means”, “˜part”, and “˜member” described in the specification indicate a comprehensive unit for performing at least one function or operation.

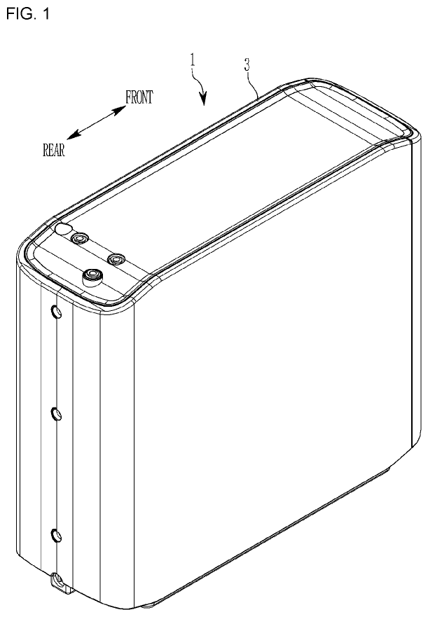

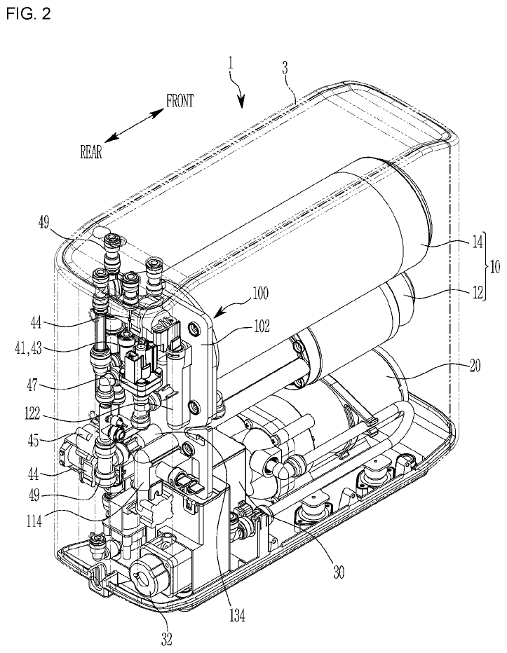

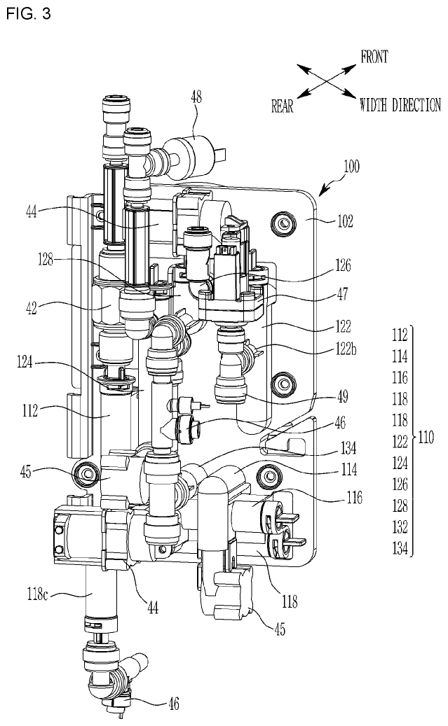

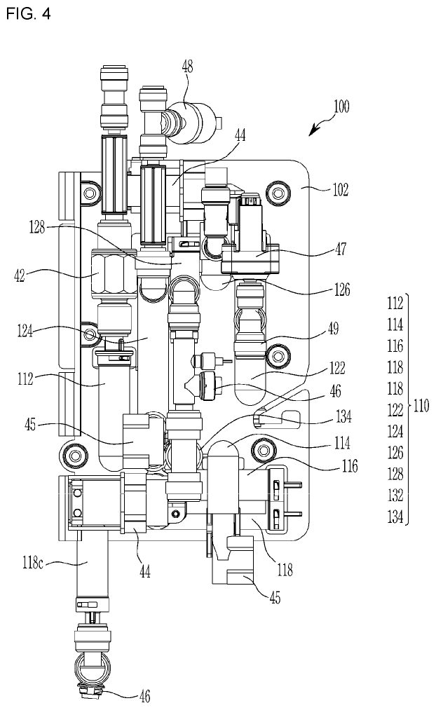

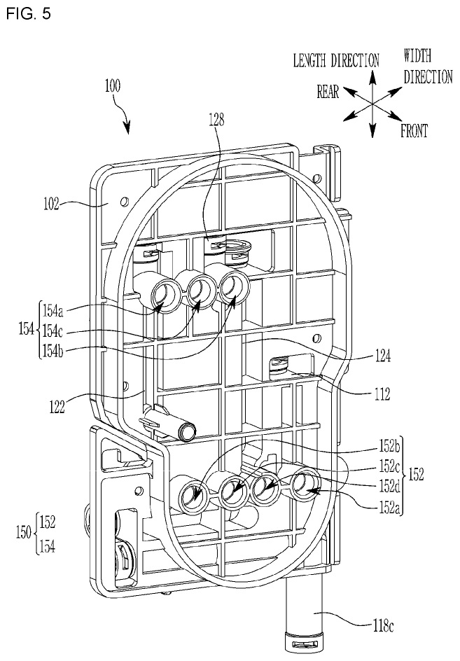

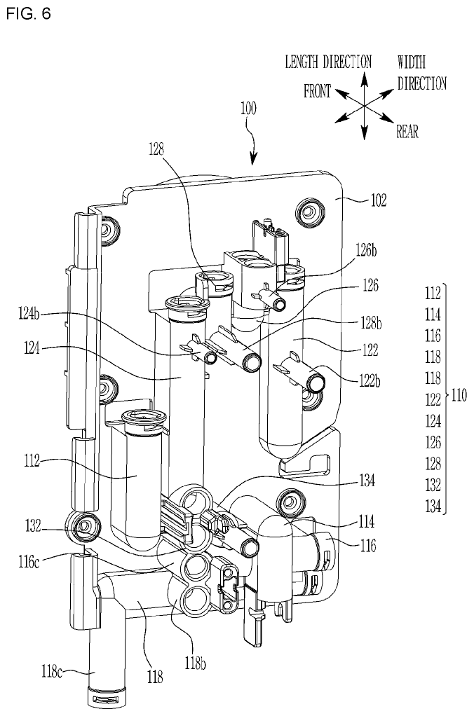

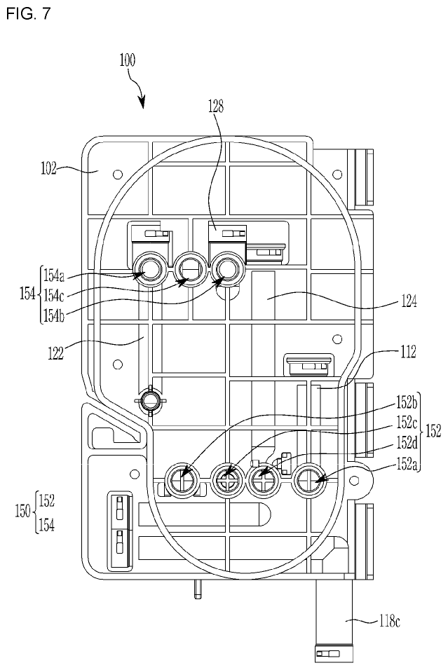

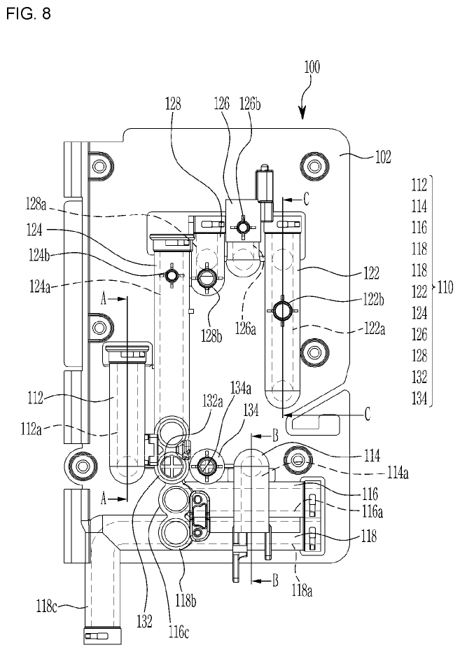

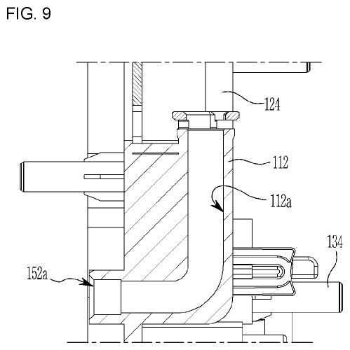

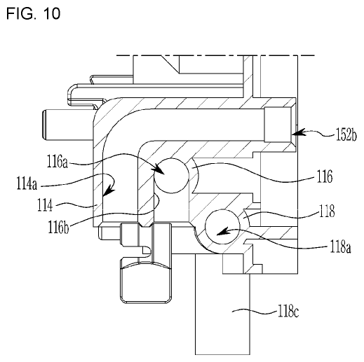

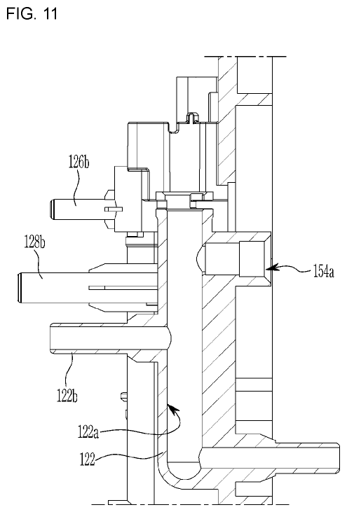

FIGS. 1 and 2 are a perspective view and a projection perspective view of a water purifier to which a flow path assembly for a water purifier is applied according to a first embodiment of the present disclosure; FIG. 3 is a rear perspective view of the flow path assembly for a water purifier according to the first embodiment of the present disclosure in which various parts are mounted; FIG. 4 is a rear view of the flow path assembly for a water purifier according to the first embodiment of the present disclosure in which various parts are mounted; FIG. 5 is a front perspective view of the flow path assembly for a water purifier according to the first embodiment of the present disclosure; FIG. 6 is a rear perspective view of the flow path assembly for a water purifier according to the first embodiment of the present disclosure; FIG. 7 is a front view of the flow path assembly for a water purifier according to the first embodiment of the present disclosure; FIG. 8 is a rear view of the flow path assembly for a water purifier according to the first embodiment of the present disclosure; FIG. 9 is a cross-sectional view taken along line A-A of FIG. 8; FIG. 10 is a cross-sectional view taken along line B-B of FIG. 8; and FIG. 11 is a cross-sectional view taken along line C-C of FIG. 8.

Referring to FIGS. 1 to 4, a flow path assembly 100 for a water purifier according to the first embodiment of the present disclosure may be applied to easily mount one or more parts and one or more filters 10 therein while integrating flow paths which are movement paths of introduced raw water with each other for introduced raw water to be filtered and purified while passing through the one or more filters 10.

Meanwhile, the description describes an embodiment in which the flow path assembly 100 according to the first embodiment of the present disclosure is applied to an under-sink type water purifier installed in a sink.

Here, a water purifier 1 may include a case 3 forming its external shape, and a pump 20 disposed in the case 3 to flow raw water for introduced raw water to pass through the one or more filters 10.

In addition, the flow path assembly 100 may be disposed in the case 3, the flow paths through which raw water or purified water flows may be integrated with each other, and the one or more filters 10 and the one or more parts are mounted therein.

Here, the one or more filters 10 may include a composite filter 12 and an osmotic pressure filter 14. The composite filter 12 may primarily filter introduced raw water, secondly filter purified water introduced again through the osmotic pressure filter 14, and discharge the same.

In addition, the osmotic pressure filter 14 may filter purified water introduced after passing through the composite filter 12 and supply the same to a flushing tank 30 or the composite filter 12.

Here, the one or more parts may include a check valve 41, a pressure reduction valve 42, a disk valve 43, a solenoid valve 44, a flow rate sensor 45, a total dissolved solids (TDS)/TMP sensor 46, a water pressure sensor 47, a cutoff switch 48, a nipple 49, and the like.

The flow path assembly 100 according to the first embodiment of the present disclosure in the water purifier configured in this way is described with reference to FIGS. 3 to 11 attached hereto.

Referring to FIGS. 3 to 11, the flow path assembly 100 according to the first embodiment of the present disclosure may include a main body 102, one or more flow path parts 110, and one or more filter mounting parts 150.

First, the main body 102 may be disposed at the rear of the water purifier 1 in the drawing, and formed into a plate shape with a predetermined thickness to be mounted in the case 3.

Here, the one or more flow path parts 110 and the one or more filter mounting parts 150 may be integrated with the main body 102 through an injection molding method or a three-dimensional (3D) printing method.

That is, the flow path assembly 100 may be made of a synthetic resin material including plastic which is a material having excellent moldability.

The one or more flow path parts 110 may each have the flow path through which raw water or purified water flows therein, and protrude from one surface of the main body 102 (or the rear of the water purifier 1 in the drawing) for the one or more parts to be mounted thereon.

In addition, the one or more filter mounting parts 150 may be formed on the other surface of the main body 102 (or the front of the water purifier 1 in the drawing) to be opposite to the one or more flow path parts 110 for the composite filter 12 and the osmotic pressure filter 14, filtering raw water introduced through one flow path part among the one or more flow path parts 110, to be respectively mounted thereon.

Here, among the flow paths respectively formed in the one or more flow path parts 110, the flow path disposed to correspond to the one or more filter mounting parts 150 may pass through the main body 102 to be connected to the one or more filter mounting parts 150 for raw water to be filtered and purified through the at least one filter 10.

In addition, the other flow paths may each be selectively connected with each other through the one part mounted on the one or more flow path parts 110.

As shown in FIGS. 4 to 11, the one or more flow path parts 110 in the first embodiment of the present disclosure may include first, second, third, fourth, fifth, sixth, seventh, eighth, ninth, and tenth path parts 112, 114, 116, 118, 122, 124, 126, 128, 132, and 134.

First, the first flow path part 112 may have a first flow path 112a formed in a vertical direction parallel to the main body 102 based on a length direction of the main body 102. The first flow path part 112 may be disposed on one side of the main body 102 (or the left side in the drawing) based on a width direction of the main body 102.

The pressure reduction valve 42 may be mounted on the first flow path part 112, and introduce raw water supplied from a raw water supply source into the first flow path 112a.

Raw water introduced into the first flow path 112a may be introduced into the composite filter 12.

The second flow path part 114 may be disposed to be spaced apart from the first flow path part 112 in the width direction of the main body 102. The second flow path part 114 may be bent toward a lower part of the main body 102 while protruding by a predetermined length from one surface of the main body 102.

In addition, the second flow path part 114 may have a second flow path 114a formed therein. Purified water filtered and purified while passing through the composite filter 12 may be introduced into the second flow path 114a.

The flow rate sensor 45 may be mounted on an end of the second flow path part 114 configured as described above that is bent toward the lower part of the main body 102.

The third flow path part 116 may be disposed at a lower part of the second flow path part 114. The third flow path part 116 may have a third flow path 116a formed in a direction perpendicular to the second flow path 114a.

Here, the second flow path part 114 may be bent into an “L” shape to partially surround the outside of the third flow path part 116.

In addition, the third flow path part 116 may further include a connection part 116b and a bent part 116c (see FIG. 10).

The connection part 116b may be formed on the third flow path part 116 at a position corresponding to the second flow path part 114 for purified water flowing into the second flow path 114a to pass through the third flow path 116a. The flow rate sensor 45 may be mounted on the connection part 116b for the third flow path 116a to be connected to the second flow path 114a.

That is, the second flow path part 114 and the flow rate sensor 45 mounted on the connection part 116b may connect the second flow path 114a and the third flow path 116a with each other.

In addition, the bent part 116c may have an end disposed to be adjacent to the first flow path part 112 and bent from one surface of the main body 102 toward the outside (or the rear of the main body 102 in the drawing).

The fourth flow path part 118 may be disposed at a lower part of the third flow path part 116. The fourth flow path part 118 may have a fourth flow path 118a formed therein a direction parallel to the third flow path 116a.

Here, the fourth flow path part 118 may further include a protrusion 118b and a pump connection part 118c.

The protrusion 118b may protrude toward the outside (or the rear of the main body 102 in the drawing) from one surface of the main body 102 to correspond to the bent part 116c to connect the third flow path 116a with the fourth flow path 118a through the one or more parts.

The solenoid valve 44 may be mounted on the bent part 116c and the protrusion 118b. The solenoid valve 44 may be operated to selectively introduce purified water flowing from the third flow path 116a to the fourth flow path 118a through the bent part 116c.

In addition, the pump connection part 118c may have an end facing the first flow path part 112 and bent toward the lower part of the main body 102. The pump connection part 118c may be connected to the pump 20 through the total dissolved solids (TDS)/TMP sensor 46 and a connection pipe.

In the first embodiment of the present disclosure, the fifth flow path part 122 may be disposed on an upper part of the main body 102 that is opposite to the first flow path part 112 based on the width direction of the main body 102.

The fifth flow path part 122 may have a fifth flow path 122a formed in a vertical direction parallel to the first flow path 112a. The fifth flow path 122a may be connected to the pump 20 through the connection pipe.

Accordingly, purified water introduced from the third flow path 116a to the fourth flow path 118a by the operation of the solenoid valve 44 may flow to the fifth flow path 122a by an operation of the pump 20.

Meanwhile, the fifth flow path part 122 may have a tank connection part 122b integrated with the fifth flow path part that protrudes in a center of the fifth flow path part 122 based on a length direction of the fifth flow path part 122 in a direction perpendicular to the fifth flow path part 122 to be connected to the flushing tank 30 for purified water stored in the flushing tank 30 to be selectively introduced into the fifth flow path 122a.

The tank connection part 122c may be connected to the flushing tank 30 through the connection pipe and the nipple 49.

In addition, the water pressure sensor 47 may be mounted above the nipple 49 mounted on the tank connection part 122c.

In the first embodiment of the present disclosure, the sixth flow path part 124 may be disposed to be spaced apart from the fifth flow path part 122 toward the first flow path part 112 based on the width direction of the main body 102. The sixth flow path part 124 may have a sixth flow path 124a formed in a direction parallel to the fifth flow path 122a.

The connection pipe (not shown) and the cutoff switch 48 may be mounted on the sixth flow path part 124 through the nipple 49 to discharge purified water flowing through the sixth flow path 124a to the outside of the water purifier 1.

The seventh flow path part 126 may be disposed between the fifth flow path part 122 and the sixth flow path part 124. The seventh flow path part 126 may have a seventh flow path 126a formed in a direction parallel to the sixth flow path 124a.

Here, the seventh flow path part 126 may allow purified water flowing through the seventh flow path 126a to be discharged as residential water through operations of the one or more parts, for example, the check valve 41 and the disk valve 43.

To this end, the seventh flow path part 126 may further include a residential water discharge part 126b protruding from an upper part based on the length direction of the seventh flow path part 126 in a direction perpendicular to the seventh flow path part 126.

The check valve 41 and the disk valve 43 may be mounted on the residential water discharge part 126b. The check valve 41 and the disk valve 43 may connect the seventh flow path 126a to the outside through a separate connection pipe.

In the first embodiment of the present disclosure, the eighth flow path part 128 may be disposed between the first flow path part 112 and the sixth flow path part 124. The eighth flow path part 128 may have an eighth flow path 128a formed in the vertical direction parallel to the first flow path 112a.

The ninth flow path part 132 may be disposed between the first flow path part 112 and the second flow path part 114 to be close to the first flow path part 112. The ninth flow path part 132 may be formed at a lower part of the sixth flow path part 124 on the main body 102.

In addition, the ninth flow path part 132 may have a ninth flow path 132a formed in a direction perpendicular to the first flow path 112a.

Meanwhile, the sixth flow path part 124 may further include a first flow path connection part 124b protruding from a lower part based on a length direction of the sixth flow path part 124 in a direction perpendicular to the sixth flow path part 124 to connect the ninth flow path 132a with the sixth flow path 124a.

The flow rate sensor 45 may be mounted on the first flow path connection part 124 and the ninth flow path part 132.

In addition, the tenth flow path part 134 may be disposed between the ninth flow path part 132 and the second flow path part 114 based on the width direction of the main body 102. The tenth flow path part 134 may have a tenth flow path 134a formed in a direction parallel to the first flow path 112a.

Here, the eighth flow path part 128 may further include a second flow path connection part 128b protruding from a lower part based on a length direction of the eighth flow path part 128 in a direction perpendicular to the eighth flow path part 128 to connect the eighth flow path 128a with the tenth flow path 134a through the one or more parts.

The second flow path connection part 128b may be connected to the tenth flow path part 134 through the total dissolved solids (TDS)/TMP sensor 46 and the nipple 49.

The first, second, third, fourth, fifth, sixth, seventh, eighth, ninth, and tenth flow paths 112a, 114a, 116a, 118a, 122a, 124a, 126a, 128a, 132a, and 134a may be formed in the main body 102 not to communicate with each other.

Alternatively, the first, second, third, fourth, fifth, sixth, seventh, eighth, ninth, and tenth flow paths 112a, 118a, 122a, 124a, 126a, 128a, 132a, and 134a may be selectively connected with each other through the one or more parts or the one or more filters 10.

That is, the first, second, third, fourth, fifth, sixth, seventh, eighth, ninth, and tenth flow paths 112a, 114a, 116a, 118a, 122a, 124a, 126a, 128a, 132a, and 134a may respectively form separate flow paths through which raw water or purified water flows in the main body 102.

Meanwhile, in the first embodiment of the present disclosure, the filter mounting part 150 may include a first filter mounting part 152 formed on a lower part of the other surface of the main body 102 (or the front of the water purifier 1 in the drawing), and a second filter mounting part 154 formed on the other surface of the main body 102 to be spaced upward from the first filter mount 152 (see FIG. 6).

First, the first filter mounting part 152 may include first and second inlet holes 152a and 152c and first and second outlet holes 152b and 152d. The composite filter 12 may be mounted on the first filter mounting part 152.

The first inlet hole 152a may communicate with the first flow path 112a, and the first outlet hole 152b may communicate with the second flow path 114a (see FIGS. 9 and 10).

Here, the first inlet hole 152a and the first outlet hole 152b may respectively be disposed on both sides of the main body 102 based on the width direction of the main body 102.

The second inlet hole 152c may communicate with the tenth flow path 134a, and the second outlet hole 152d may communicate with the ninth flow path 132a.

Here, the second inlet hole 152c may be disposed between the first inlet hole 152a and the first outlet hole 152b to be close to the first outlet hole 152b.

In addition, the second outlet hole 152d may be disposed between the first inlet hole 152a and the first outlet hole 152c to be close to the first inlet hole 152a.

The first and second inlet holes 152a and 152c and the first and second outlet holes 152b and 152d, configured in this way, may be disposed on the same line in the width direction of the main body 102.

In addition, the second filter mounting part 154 may include a third inlet hole 154a, a third outlet hole 154b, and a residential water outlet hole 154c. The osmotic pressure filter 14 may be mounted on the second filter mounting part 154.

In this embodiment, the third inlet hole 154a may communicate with the fifth flow path 122a (see FIG. 11). The third outlet hole 154b may communicate with the eighth flow path 128a. In addition, the residential water outlet hole 154c may communicate with the seventh flow path 126a.

The third inlet hole 154a, the third outlet hole 154b, and the residential water outlet hole 154c, configured in this way, may be disposed on the same line in the width direction of the main body 102.

Here, the composite filter 12 may primarily filter raw water introduced through the first inlet hole 152a to thus discharge the same through the first outlet hole 152b, and secondly filter purified water passed through the osmotic pressure filter 14 and then introduced through the second inlet hole 152c to thus discharge the same through the second outlet hole 152d.

In addition, the osmotic pressure filter 14 may filter purified water introduced into the third inlet hole 154a and supply the same to the flushing tank 30 or the composite filter 12 through the third outlet hole 154b.

Here, when a user operates the water purifier, the pump 20 may be operated for raw water introduced into the water purifier 1 to pass through each of the flow paths, the composite filter 12, and the osmotic pressure filter 14.

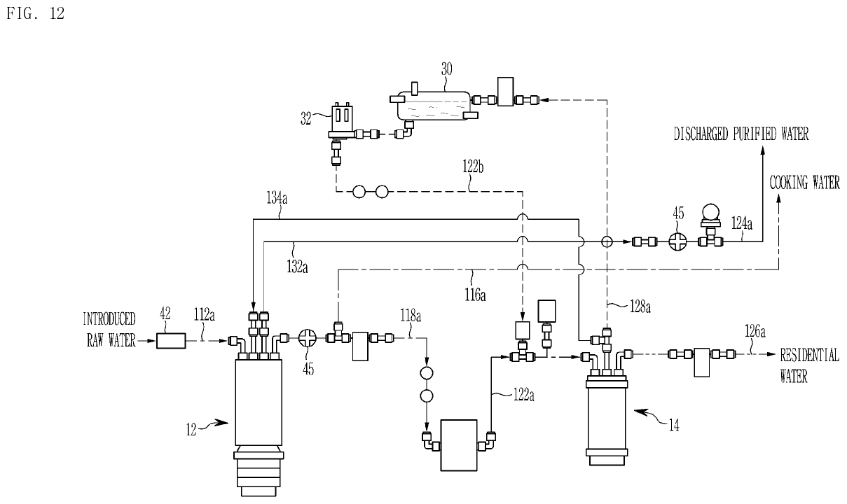

The description describes a flow of raw water or purified water in the flow path assembly 100 for a water purifier configured as described above with reference to FIG. 12.

FIG. 12 is a view of the flow in the flow path and shows the flows of raw water and purified water in a water purifier to which the flow path assembly for a water purifier according to the first embodiment of the present disclosure is applied.

First, when the user operates the water purifier 1, raw water supplied from the raw water supply source may be introduced into the first flow path part 112 by the operation of the pump 20.

Here, raw water introduced into the first flow path part 112 may flow to the first flow path 112a while having a reduced pressure by an operation of the pressure reduction valve 42, and may be introduced into the composite filter 12 through the first inlet hole 152a which communicates with the first flow path 112a.

Raw water introduced into the composite filter 12 may be filtered and purified while primarily passing through the composite filter 12, and purified water may be discharged through the first outlet hole 152b and introduced into the second flow path 114a of the second flow path part 114.

Purified water introduced into the second flow path 114a may be introduced into the third flow path 116a of the third flow path part 116, which communicates with the second flow path 114a, through the connection part 116b and the flow rate sensor 45.

Among purified water introduced into the third flow path 116a, some purified water may be discharged as cooking water based on the user's operation. Remaining purified water may be introduced to the pump connection part 118c by an operation of the solenoid valve 44 mounted on the bent part 116c and the protrusion 118b.

Purified water introduced into the pump connection part 118c may pass through the pump 20, may be introduced into the osmotic pressure filter 14 through the third inlet hole 154a which communicates with the fifth flow path 122a of the fifth flow path part 122, and may be filtered and purified while passing through the osmotic pressure filter 14.

Among purified water passed through the osmotic pressure filter 14, some purified water discharged through the third outlet hole 154b may be introduced into the flushing tank 30. Remaining purified water discharged through the third outlet hole 154b may pass through the total dissolved solids (TDS)/TMP sensor 46 to be introduced into the tenth flow path 134a of the tenth flow path part 134.

Purified water introduced into the tenth flow path 134a may be secondly introduced into the composite filter 12 through the second inlet hole 152c which communicates with the tenth flow path 134a.

In addition, among purified water passed through the osmotic pressure filter 14, some purified water may be introduced into the seventh flow path 126a of the seventh flow path part 126 through the residential water outlet hole 154c based on the user's operation, and may be discharged to the residential water discharge part 126b.

Meanwhile, purified water introduced into the flushing tank 30 may be stored in the flushing tank 30 and may be introduced into the fifth flow path 122a through the tank connection part 122b formed on the fifth flow path part 122 by a selective operation of the flushing pump 32.

Purified water filtered and purified again while secondly passing through the composite filter 12 may be discharged to the ninth flow path 132a of the ninth flow path part 132 through the second outlet hole 154d, and introduced into the sixth flow path 124a of the sixth flow path part 124 connected with the ninth flow path 132a through the flow rate sensor 45.

Purified water introduced through the sixth flow path 124a may be supplied to the user in a completed state based on the user's operation.

Meanwhile, the description describes an embodiment in which the water purifier 1, to which the flow path assembly 100 for a water purifier according to the first embodiment of the present disclosure is applied, filters and purifies introduced raw water. However, the present disclosure is not limited thereto, and devices for cooling or heating purified water to supply cold water or hot water may be disposed in the water purifier 1 to meet the user's need.

In addition, the description describes an embodiment in which the flow path assembly 100 for a water purifier according to the first embodiment of the present disclosure is applied to the direct-type water purifier 1 that filters and purifies introduced raw water and supplies the same directly to the user. However, the present disclosure is not limited thereto, and the assembly 100 may also be applied to a storage-type water purifier that filters, purifies and stores introduced raw water and then supplies stored purified water to the user.

In addition, the description describes the water purifier to which the flow path assembly 100 according to the first embodiment of the present disclosure is applied is an under-sink type water purifier installed in the sink, and the introduction of raw water and the discharges of purified water, residential water, and cooking water are each connected to the pipes. However, the present disclosure is not limited thereto.

That is, the flow path assembly 100 of the present disclosure may be applied to a general water purifier exposed to the outside, rather than the under-sink type. In this case, a faucet for discharging purified water, residential water, and cooking water directly from the water purifier may be mounted on a part where purified water, residential water, and cooking water are discharged, by the user's operation.

Therefore, when applying the flow path assembly 100 for a water purifier according to the first embodiment of the present disclosure configured as described above, it is possible to easily mount the various parts, the composite filter 12, and the osmotic pressure filter 14 therein, while integrating the flow paths which are the movement paths of introduced raw water with each other.

In addition, the first embodiment of the present disclosure may minimize the usage of pipes by applying the first to tenth flow path parts 112, 114, 116, 118, 122, 124, 126, 128, 132, and 134, that is, the plurality of flow path parts integrated with each other without a fusion work, and simultaneously have improved workability while shortening the assembly and replacement time of the composite filter 12, the osmotic pressure filter 14 and each part by securing an internal space.

In addition, the first embodiment of the present disclosure may improve maintainability by easily assembling and disassembling each component and the various parts, reduce a production cost by reducing the overall number of parts, and improve productivity.

In addition, the first embodiment of the present disclosure may minimize occurrence of a product defect by improving airtightness by preventing leakage or damage due to a pressure of raw water, and reduce an overall size of the water purifier by promoting a smaller size, thereby improving overall marketability.

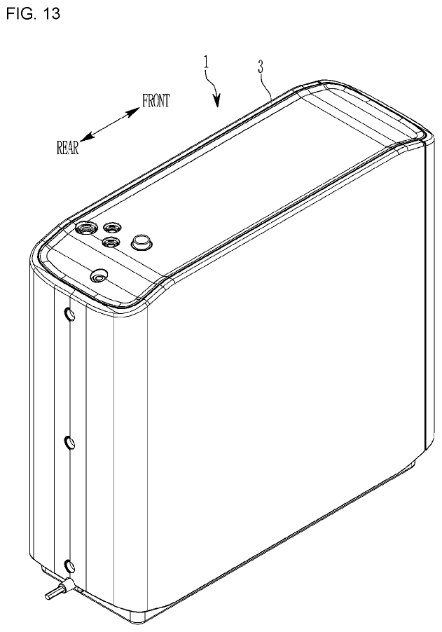

In addition, a flow path assembly 1000 for a water purifier according to the second embodiment of the present disclosure is described with reference to FIGS. 13 to 24 attached hereto.

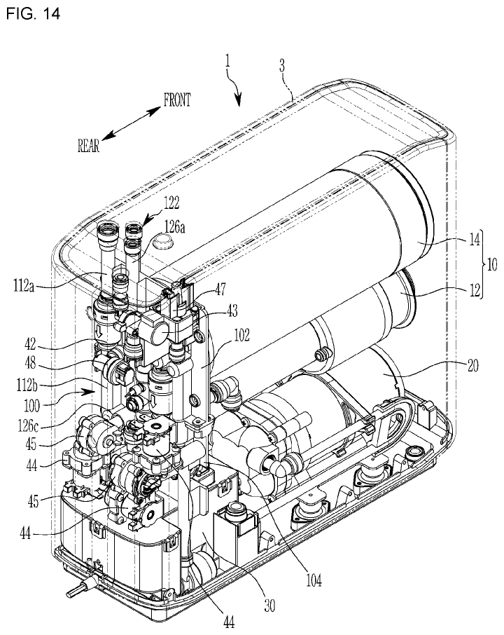

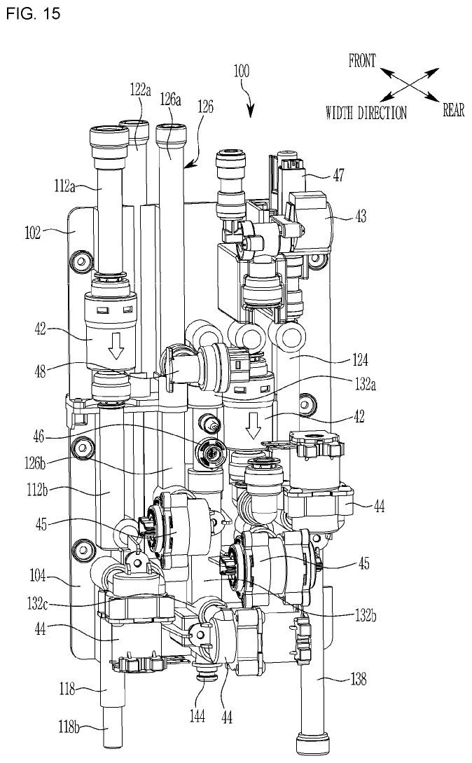

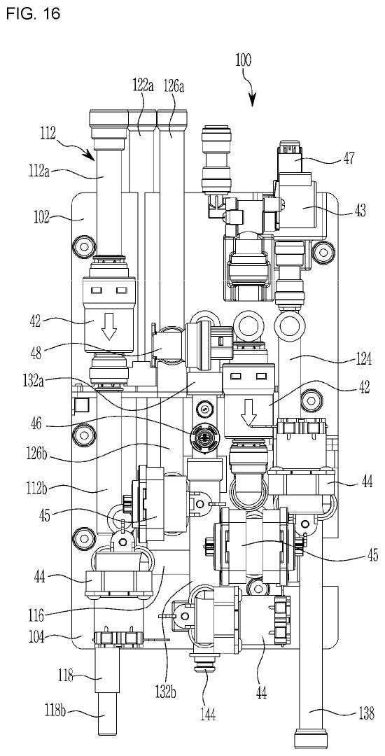

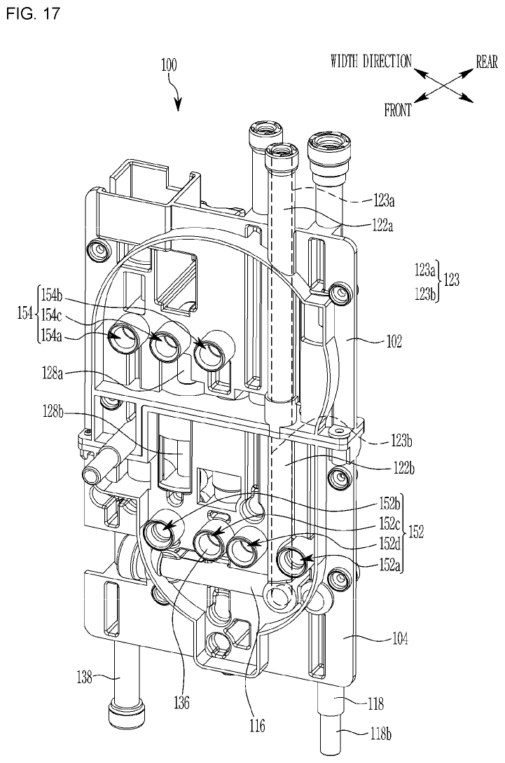

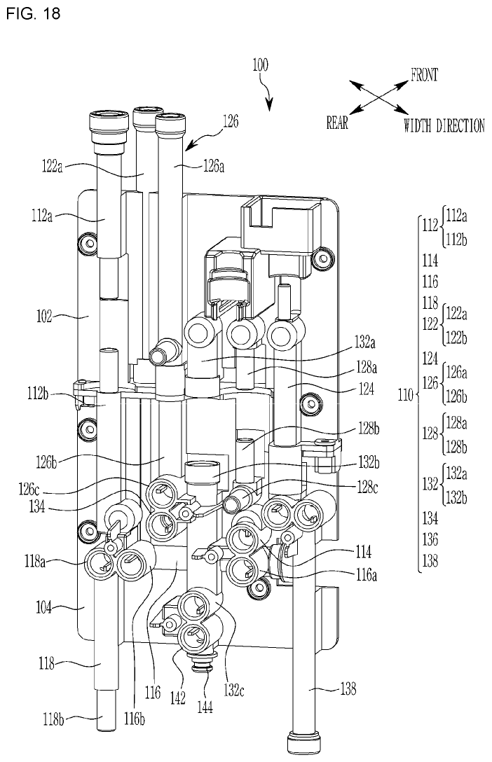

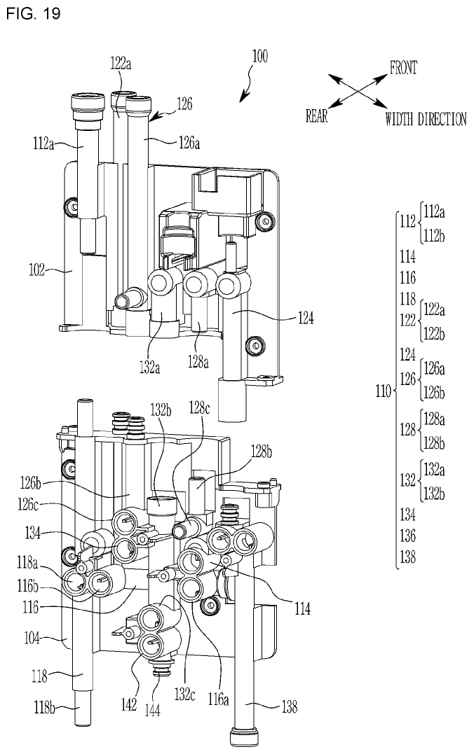

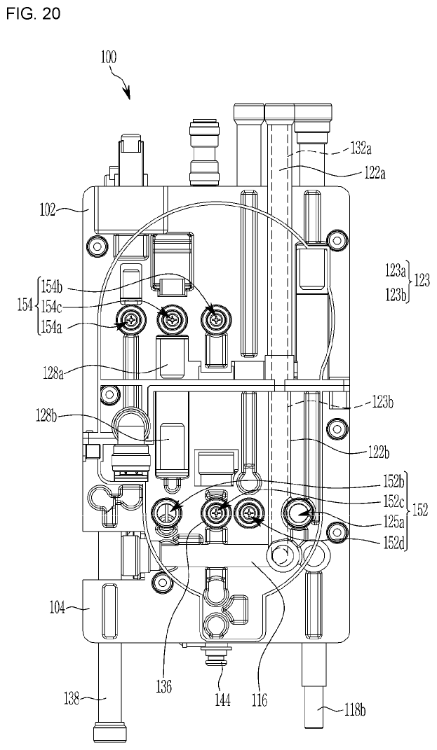

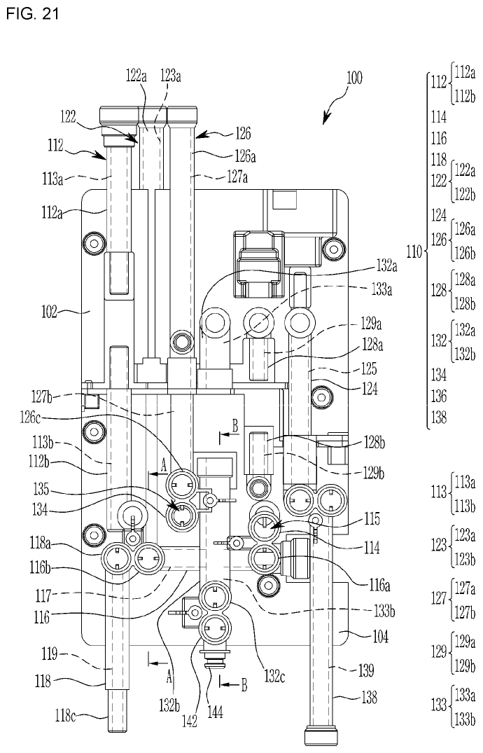

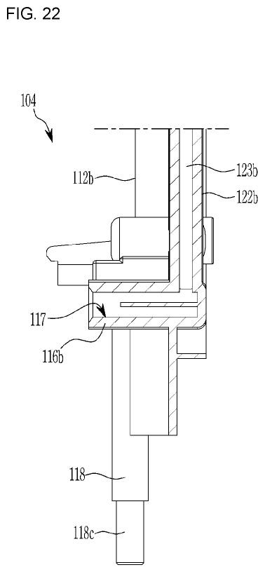

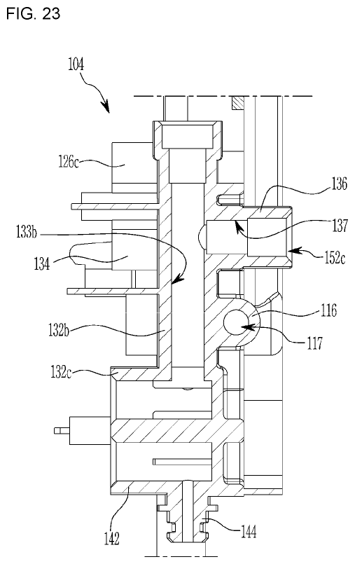

FIG. 13 is a perspective view of a water purifier to which a flow path assembly for a water purifier according to a second embodiment of the present disclosure is applied; FIG. 14 is a projection perspective view of the water purifier to which the flow path assembly for a water purifier is applied according to the second embodiment of the present disclosure; FIG. 15 is a rear perspective view of the flow path assembly for a water purifier in which various parts are mounted according to the second embodiment of the present disclosure; FIG. 16 is a rear view of the flow path assembly for a water purifier in which various parts are mounted according to the second embodiment of the present disclosure; FIG. 17 is a front perspective view of the flow path assembly for a water purifier according to the second embodiment of the present disclosure; FIG. 18 is a rear perspective view of the flow path assembly for a water purifier according to the second embodiment of the present disclosure; FIG. 19 is an exploded perspective view of the flow path assembly for a water purifier according to the second embodiment of the present disclosure; FIG. 20 is a front view of the flow path assembly for a water purifier according to the second embodiment of the present disclosure; FIG. 21 is a rear view of the flow path assembly for a water purifier according to the second embodiment of the present disclosure; FIG. 22 is a cross-sectional view taken along line X-X of FIG. 21; and FIG. 23 is a cross-sectional view taken along line Y-Y of FIG. 21.

Meanwhile, in describing the flow path assembly 1000 for a water purifier according to the second embodiment of the present disclosure, the same components as the first embodiment of the present disclosure are denoted by the same reference numerals.

Referring to FIGS. 13 to 16, the flow path assembly 1000 for a water purifier according to the second embodiment of the present disclosure may be applied to easily mount one or more parts and one or more filters 10 therein while integrating flow paths which are movement paths of introduced raw water with each other for introduced raw water to be filtered and purified while passing through the one or more filters 10.

Meanwhile, the description describes an embodiment in which the flow path assembly 1000 according to this embodiment of the present disclosure is applied to an under-sink type water purifier installed in a sink.

Here, a water purifier 1 may include a case 3 forming its external shape, and a pump 20 disposed in the case 3 to flow raw water for introduced raw water to pass through the one or more filters 10.

In addition, the flow path assembly 1000 may be disposed in the case 3, the flow paths through which raw water or purified water flows may be integrated with each other, and the one or more filters 10 and the one or more parts are mounted therein.

Here, the one or more filters 10 may include a composite filter 12 and an osmotic pressure filter 14. The composite filter 12 may primarily filter introduced raw water, secondly filter purified water introduced again through the osmotic pressure filter 14, and discharge the same.

In addition, the osmotic pressure filter 14 may filter purified water introduced after passing through the composite filter 12 and supply the same to a flushing tank 30 or the composite filter 12.

Here, the one or more parts may include a check valve 41, a pressure reduction valve 42, a disk valve 43, a solenoid valve 44, a flow rate sensor 45, a total dissolved solids (TDS)/TMP sensor 46, a water pressure sensor 47, a cutoff switch 48, a nipple 49, and the like.

The flow path assembly 1000 according to the second embodiment of the present disclosure in the water purifier configured in this way is described with reference to FIGS. 15 to 23 attached hereto.

Referring to FIGS. 15 to 23, the flow path assembly 1000 according to the second embodiment of the present disclosure may include a first body 1020, a second body 1040, one or more flow path parts 1100, and one or more filter mounting parts 1500.

First, the first body 1020 and the second body 1040 may be disposed at the rear of the water purifier 1 in the drawing, and configured to be separated from each other to be coupled with each other.

These first and second bodies 1020 and 1040 may be assembled with each other through fastening means. That is, the first body 1020 may be disposed at an upper part in the drawing, and the second body 1040 may be disposed at a lower part in the drawing, and assembled with each other through screw fastening.

These first and second bodies 1020 and 1040 may be coupled to each other and formed into a plate shape with a predetermined thickness to be mounted in the case 3.

Here, the one or more flow path parts 1100 and the one or more filter mounting parts 1500 may be integrated with the first and second bodies 1020 and 1040 through an injection molding method or a three-dimensional (3D) printing method.

That is, the flow path assembly 1000 may be made of a synthetic resin material including plastic which is a material having excellent moldability.

The one or more flow path parts 1100 may each have the flow path through which raw water or purified water flows therein, and protrude from one surface (i.e., the rear of the water purifier 1 in the drawing) or the other surface (i.e., the front of the water purifier 1 in the drawing) of each of the first and second bodies 1020 and 1040 for the one or more parts to be mounted thereon.

In addition, the one or more filter mounting parts 1500 may be formed on the other surface of the first and second bodies 1020 and 1040 (or the front of the water purifier 1 in the drawing) for the composite filter 12 and the osmotic pressure filter 14, which filter raw water introduced through one flow path part, among the one or more flow path parts 1100, to be respectively mounted thereon.

Among the one or more flow path parts 1100, the one or more flow path parts 1100 formed at corresponding positions on one surface or the other surface of each of the first body 1020 and the second body 1040 may be connected with each other directly or through the one or more parts in a state where the first body 1020 and the second body 1040 are coupled with each other.

In addition, among the flow paths respectively formed in the one or more flow path parts 1100, the flow paths respectively disposed to correspond to the one or more filter mounting parts 1500 may pass through the first body 1020 or the second body 1040 to be connected to the one or more filter mounting parts 1500 for raw water to be purified water through the at least one filter 10.

In addition, the other flow paths may be selectively connected with each other, respectively, through the one or more flow path parts 1100 directly connected thereto or through the one or more parts mounted on the one or more flow path parts 1100.

As shown in FIGS. 16 to 23, the one or more flow path parts 1100 in this embodiment of the present disclosure may include first, second, third, fourth, fifth, sixth, seventh, eighth, ninth, tenth, eleventh, and twelfth path parts 1120, 1140, 1160, 1180, 1220, 1240, 1260, 1280, 1320, 1340, 1360, and 1380.

First, the first flow path part 1120 may be formed on one surface of each of the first and second bodies 1020 and 1040 (or the rear of each of the first and second bodies 1020 and 1040 in the drawing). The first flow path part 1120 may have a first flow path 1130 formed in a vertical direction parallel to the first and second bodies 1020 and 1040 based on length directions of the first and second bodies 1020 and 1040.

The first flow path part 1120 may be disposed on one side of each of the first and second bodies 1020 and 1040 (or the left side in the drawing) based on width directions of the first and second bodies 1020 and 1040.

The pressure reduction valve 42 may be mounted on the first flow path part 1120, and introduce raw water supplied from a raw water supply source into the first flow path 1130.

Here, the first flow path part 112 may include a first upper flow path part 1120a and a first lower flow path part 1120b.

First, the first upper flow path part 1120a may be formed on one surface of the first body 1020 (or the rear of the first body 1020 in the drawing). The first upper flow path part 1120a may have a first upper flow path 1130a formed in the vertical direction parallel to the first body 1020 along the length direction of the first body 1020.

In addition, the first lower flow path part 1120b may be formed on one surface of the second body 1040 (or the rear of the second body 1040 in the drawing) to correspond to the first upper flow path part 1120a. The first lower flow path part 1120b may have a first lower flow path 1130a formed in the vertical direction parallel to the second body 1040 along the length direction of the second body 1040.

Here, the first upper flow path 1130a and the first lower flow path 1130b may communicate with each other by the pressure reduction valve 42 mounted between the first upper flow path part 1120a and the first lower flow path part 1120b.

That is, the pressure reduction valve 42 may be mounted between the first upper flow path part 1120a and the first lower flow path part 1120b, and may connect the first upper flow path 1130a with the second lower flow path 1130b.

Accordingly, raw water introduced into the first flow path 1130 may be introduced into the composite filter 12 by an operation of the pressure reduction valve 42.

In the second embodiment of the present disclosure, the second flow path part 1140 may be disposed to be spaced apart from the first flow path part 1120 in the width direction of the second body 1040.

The second flow path part 1140 may protrude by a predetermined length from one surface of the second body 1040 (or the rear of the second body 1040 in the drawing). In addition, the second flow path part 1140 may have a second flow path 1150 formed therein.

Purified water filtered and purified while passing through the composite filter 12 may be introduced into the second flow path 1150.

The third flow path part 1160 may be disposed at a lower part of the second flow path part 1140 on one surface of the second body 1040 (or the rear of the second body 104 in the drawing).

The third flow path part 1160 may have both ends protruding from one surface of the second body 1040 based on the width direction of the second body 1040. In addition, the third flow path part 1160 may have a third flow path 1170 formed therein.

The fourth flow path part 1180 may be disposed at a lower part of the first lower flow path part 1120a on one surface of the second body 1040 (or the rear of the second body 1040 in the drawing). The fourth flow path part 1180 may have a fourth flow path 1190 formed in a vertical direction parallel to the first lower flow path part 1120a.

Here, the third flow path part 1160 may further include first and second bent parts 1160a and 1160b.

First, the first bent part 1160a may have one end corresponding to the second flow path part 1140 that is bent from one surface of the second body 1040 toward the outside (or the rear of the second body 1040 in the drawing) based on the width direction of the second body 1040.

Here, the flow rate sensor 45 may be mounted on the first bent part 1160a and the second flow path part 1140. That is, the flow rate sensor 45 may be mounted on the second flow path part 1140 and the third flow path part 1160 for the second flow path 1150 and the third flow path 1170 to communicate with each other.

Accordingly, purified water introduced to the second flow path 1150 may be introduced to the third flow path 1170 through the flow rate sensor 45.

In addition, the second bent part 1160b may have the other end corresponding to the fourth flow path part 1180 that is bent from one surface of the second body 1040 toward the outside (or the rear of the second body 1040 in the drawing).

In addition, the fourth flow path part 1180 may further include a third bent part 118b and a pump connection part 1180b.

First, the third bent part 118b may have one end corresponding to the second bent part 1160b that is bent from one surface of the second body 1040 toward the outside (or the rear of the second body 1040 in the drawing) to connect the third flow path 1170 with the fourth flow path 1190 through the one or more parts.

Here, the solenoid valve 44 may be mounted on the second bent part 1160b and the third bent part 118b.

The solenoid valve 44 may be operated to selectively introduce purified water flowing from the third flow path 1170 through the second bent part 1160b to the fourth flow path 1190 through the third bent part 118b.

That is, the third flow path 1170 and the fourth flow path 1190 may communicate with each other by the selective operation of the solenoid valve 44. Accordingly, purified water introduced into the third flow path 1170 may be introduced into the fourth flow path 1190 by the operation of the solenoid valve 44.

In addition, the pump connection part 1180b may protrude toward the bottom of the second body 1040. The pump connection part 1180b may be connected to the pump 20 through the total dissolved solids (TDS)/TMP sensor 46 and a connection pipe.

In the second embodiment of the present disclosure, the fifth flow path part 1220 may be formed on the other surface of each of the first and second bodies 1020 and 1040 (or the front of the first and second bodies 1020 and 1040) to be close to the first flow path part 1120 based on the width directions of the first and second bodies 1020 and 1040.

The fifth flow path part 1220 may have a fifth flow path 1230 formed in a vertical direction parallel to the first flow path 1130.

Here, the fifth flow path part 1220 may include a fifth upper flow path part 1220a and a fifth lower flow path part 1220b.

First, the fifth upper flow path part 1220a may be formed on the other surface of the first body 1020 (or the front of the first body 1020 in the drawing) to be close to the first upper flow path part 1120a based on the width direction of the first body 1020.

The fifth upper flow path part 1220a may have a fifth upper flow path 1230a formed in the vertical direction parallel to the first body 1020 along the length direction of the first body 1020.

In addition, the fifth lower flow path part 1120b may be formed on the other surface of the second body 1040 (or the front of the second body 1040 in the drawing) to correspond to the fifth upper flow path part 1220a.

The fifth lower flow path part 1220b may have a fifth lower flow path 1230b formed in the vertical direction parallel to the second body 1040 along the length direction of the second body 1040.

Here, the fifth upper flow path 1230a and the fifth lower flow path 1230b may directly communicate with each other as the fifth upper flow path part 1220a and the fifth lower flow path part 1220b are coupled with each other by the first and second bodies 1020 and 1040 that are coupled with each other.

In addition, the fifth flow path 1230 may communicate with the third flow path 1170.

That is, the fifth lower flow path 1230b forming the fifth flow path 1230 may pass through the second body 1040 at a position corresponding to the second bent part 1160 of the third flow path part 1160 to be connected to the third flow path 1170 (see FIG. 22).

Accordingly, among purified water passing through the third flow path 1170, some purified water may be discharged as cooking water through the fifth flow path 1230 of the fifth flow path part 1220 based on a user's operation.

In the second embodiment of the present disclosure, the sixth flow path part 1240 may be disposed to be spaced apart from and opposite to the first flow path part 1120 based on the width direction of the first body 1020. The sixth flow path part 1240 may have a sixth flow path 1250 formed in a direction parallel to the fifth flow path 1230.

Purified water passed through the fourth flow path 1190 may flow in the sixth flow path 1250 by an operation of the pump 20.

Here, the water pressure sensor 47 may be mounted on an upper part of the sixth flow path part 1240.

The seventh flow path part 1260 may be formed on one surface of each of the first and second bodies 1020 and 1040 (or the rear of the first and second bodies 1020 and 1040) to be close to the fifth flow path part 1220 based on the width directions of the first and second bodies 1020 and 1040.

The seventh flow path part 1260 may have a seventh flow path 1270 formed in the vertical direction parallel to the first flow path 1130.

Here, the seventh flow path part 1260 may include a seventh upper flow path part 1260a and a seventh lower flow path part 1260b.

First, the seventh upper flow path part 1260a may be formed on one surface of the first body 1020 (or the rear of the first body 1020 in the drawing) to be close to the fifth upper flow path part 1220a based on the width direction of the first body 1020.

The seventh upper flow path part 1260a may have a seventh upper flow path 1270a formed in the vertical direction parallel to the first body 1020 along the length direction of the first body 1020.

Here, the cutoff switch 48 may be mounted on the seventh upper flow path part 1260a.

In addition, the seventh lower flow path part 1120b may be formed on one surface of the second body 1040 (or the rear of the second body 1040 in the drawing) to correspond to the seventh upper flow path part 1260a.

The seventh lower flow path part 1120b may have a seventh lower flow path 1270b formed in the vertical direction parallel to the second body 1040 along the length direction of the second body 1040.

Here, the seventh upper flow path 1270a and the seventh lower flow path 1270b may directly communicate with each other as the seventh upper flow path part 1260a and the seventh lower flow path part 126b are coupled with each other by the first and second bodies 1020 and 1040 that are coupled with each other.

Purified water introduced through the seventh flow path 1270 may be supplied to the user in a completed state based on the user's operation.

In the second embodiment of the present disclosure, the eighth flow path part 1280 may be formed on one surface of each of the first and second bodies 1020 and 1040 (or the rear of each of the first and second bodies 1020 and 1040 in the drawing) between the sixth flow path part 1240 and the seventh flow path part 1260 to be close to the sixth flow path part 1240.

The eighth flow path part 1280 may have an eighth flow path 1290 formed in the vertical direction parallel to the first flow path 1130.

Here, the eighth flow path part 1280 may include an eighth upper flow path part 1280a and an eighth lower flow path part 1280b.

First, the eighth upper flow path part 1280a may be formed on one surface of the first body 1020. The eighth upper flow path part 1280a may have an eighth upper flow path 1290a formed in the vertical direction parallel to the first body 1020 along the length direction of the first body 1020.

In addition, the eighth lower flow path part 1280b may be formed on one surface of the second body 1040 to correspond to the eighth upper flow path part 1280a. The eighth lower flow path part 1280b may have an eighth lower flow path 1290b formed in the vertical direction parallel to the second body 1040 along the length direction of the second body 1040.

The eighth upper flow path 1290a and the eighth lower flow path 1290b may communicate with each other by the pressure reduction valve 42 mounted between the eighth upper flow path part 1280a and the eighth lower flow path part 1280b.

That is, the pressure reduction valve 42 may be mounted between the eighth upper flow path part 1280a and the eighth lower flow path part 1280b, and may connect the eighth upper flow path 1290a with the second lower flow path 1290b.

Here, the eighth lower flow path part 1280b may further include a residential water discharge part 1280c protruding in a direction perpendicular to the eighth lower flow path part 1280b for purified water flowing through the eighth lower flow path 1290b to be discharged as residential water by the operation of the disk valve 43.

The residential water discharge part 1280c may be connected to the disk valve 43 through the connection pipe, and the nipple 49 may be mounted on the disk valve 43 to connect a hose from the outside of the water purifier 1.

In the second embodiment of the present disclosure, the ninth flow path part 1320 may be formed on one surface of each of the first and second bodies 1020 and 1040 (or the rear of each of the first and second bodies 102 and 1040 in the drawing) between the seventh flow path part 1260 and the eighth flow path part 1280.

The ninth flow path part 1320 may have a ninth flow path 1330 formed in the vertical direction parallel to the first flow path 1130.

Here, the ninth flow path part 1320 may include a ninth upper flow path part 1320a and a ninth lower flow path part 1320b.

First, the ninth upper flow path part 1320a may be formed on one surface of the first body 1020. The ninth upper flow path part 1320a may have a ninth upper flow path 1330a formed in the vertical direction parallel to the first body 1020 along the length direction of the first body 1020.

In addition, the ninth lower flow path part 1320b may be formed on one surface of the second body 1040 to correspond to the ninth upper flow path part 1320a. The ninth lower flow path part 1320b may have a ninth lower flow path 1330b formed in the vertical direction parallel to the second body 1040 along the length direction of the second body 1040.

Here, the ninth upper flow path 1330a and the ninth lower flow path 1330b may communicate with each other by the connection pipe mounted with the total dissolved solids (TDS)/TMP sensor 46 mounted between the ninth upper flow path part 1320a and the ninth lower flow path part 1320b.

In addition, the ninth lower flow path part 1320b may be formed to surround the outside of the third flow path part 1160.

In the second embodiment of the present disclosure, the ninth lower flow path part 1320b may further include a tank connection part 1320c bent toward the outside from the lower part of one surface of the second body 1040 based on the length direction of the second body 1040.

A tank mounting part 1420 which is connected with the tank connection part 1320c through the one or more parts, and into which purified water flows for purified water passed through the ninth lower flow path 1330b to be stored in the flushing tank 30 may be formed at a lower part of the tank connection part 1320c on one surface of the second body 1040 and integrated with the tank connection part 1320c.

The solenoid valve 44 may be mounted on the tank connection part 1320c and the tank mounting part 1420. The solenoid valve 44 may be operated to selectively introduce purified water flowing through the ninth flow path 1330 into the tank mounting part 1420.

Meanwhile, the tank mounting part 1420 may further include a tank port 1440 protruding downward based on the length direction of the second body 1040 for the flushing tank 30 to be directly connected thereto.

Accordingly, the flushing tank 30 may be directly mounted on the second body 1040 through the tank port 1440.

In the second embodiment of the present disclosure, the tenth flow path part 1340 may be disposed at a lower part of the seventh flow path part 1260 on one surface of the second body 1040. The tenth flow path part 1340 may have a tenth flow path 1350 formed in a direction perpendicular to the first flow path 1130.

Here, the seventh flow path part 1260 may further include a flow path connection part 1260c protruding from a lower part in a direction parallel to the tenth flow path part 1340 based on a length direction of the seventh flow path part 1260 to connect the tenth flow path 1350 with the seventh flow path 1270 through the flow rate sensor 45.

That is, the flow rate sensor 45 may be mounted on the flow path connection part 1260c and the tenth flow path part 1340.

The eleventh flow path part 1360 may be formed at a position corresponding to the ninth flow path part 1320 on the other surface of the second body 1040. The eleventh flow path part 1360 may have an eleventh flow path 1370 formed in the direction perpendicular to the first flow path 1130.

Here, the eleventh flow path 1370 may pass through the second body 1040 to communicate with the ninth lower flow path 1330b (see FIG. 23).

In addition, the twelfth flow path part 1380 may be disposed to be spaced apart from one surface of the second body 1040 to be opposite to the fourth flow path part 1180 based on the width direction of the second body 1040. The twelfth flow path part 1380 may have a twelfth flow path 1390 formed in a vertical direction parallel to the first flow path 1130.

Here, the twelfth flow path part 1380 may be connected to the flushing tank 30 through the connection pipe and a flushing pump 32 for purified water stored in the flushing tank 30 to be selectively introduced to the twelfth flow path 1390.

In addition, the twelfth flow path 1390 may be connected to the sixth flow path 1250 through the solenoid valve 44 to selectively supply purified water introduced from the flushing tank 30 to the sixth flow path 1250.

The solenoid valve 44 may be operated to selectively introduce purified water supplied from the twelfth flow path 1390 to the sixth flow path 1250.

The first, second, fourth, sixth, seventh, eighth, tenth, and twelfth flow paths 1130, 1150, 1190, 1250, 1270, 1290, 1350, and 1390 configured in this way may be formed in the first and second bodies 1020 and 1040 not to communicate with each other.

Alternatively, the first, second, fourth, sixth, seventh, eighth, tenth, and twelfth flow paths 1130, 1150, 1190, 1250, 1270, 1290, 1350, and 1390 may be selectively connected with each other through the one or more parts or the one or more filters 10.

That is, except for the third flow path 1170 and the fifth flow path 1230 communicating with each other, and the ninth flow path 1330 and the eleventh flow path 1370 communicating with each other, the remaining first, second, fourth, sixth, seventh, eighth, tenth, and twelfth flow paths 1130, 1150, 1190, 1250, 1270, 1290, 1350 and 1390 may respectively form separate flow paths through which raw water or purified water flows in the first and second bodies 1020 and 1040.

Meanwhile, in the second embodiment of the present disclosure, the filter mounting part 1500 may include a first filter mounting part 1520 formed on the other surface of the second body 1040 (or the front of the water purifier 1 in the drawing) and a second filter mounting part 1540 formed on the other surface of the first body 1020 to be spaced upward from the first filter mounting part 1520 (see FIG. 18).

First, the first filter mounting part 1520 may include first and second inlet holes 1520a and 1520c and first and second outlet holes 1520b and 1520d. The composite filter 12 may be mounted on the first filter mounting part 1520.

The first inlet hole 1520a may communicate with the first flow path 1130, and the first outlet hole 1520b may communicate with the second flow path 1150 (see FIGS. 20 and 21).

Here, the first inlet hole 1520a and the first outlet hole 1520b may respectively be disposed on both sides of the second body 1040 based on the width direction of the second body 1040.

The second inlet hole 1520c may communicate with the eleventh flow path 1370, and the second outlet hole 1520d may communicate with the tenth flow path 1350.

Here, the second inlet hole 1520c may be disposed between the first inlet hole 1520a and the first outlet hole 1520b to be close to the first outlet hole 1520b. In addition, the second outlet hole 1520d may be disposed between the first inlet hole 1520a and the first outlet hole 1520c to be close to the first inlet hole 1520a.

The first and second inlet holes 1520a and 1520c and the first and second outlet holes 1520b and 1520d, configured in this way, may be disposed on the same line in the width direction of the main body 1020.

In addition, the second filter mounting part 1540 may include a third inlet hole 1540a, a third outlet hole 1540b, and a residential water outlet hole 1540c. The osmotic pressure filter 14 may be mounted on the second filter mounting part 1540.

In the second embodiment of the present disclosure, the third inlet hole 1540a may communicate with the sixth flow path 1250. The third outlet hole 1540b may communicate with the ninth flow path 1330. In addition, the residential water outlet hole 1540c may communicate with the eighth flow path 1290.

The third inlet hole 1540a, the third outlet hole 1540b, and the residential water outlet hole 1540c, configured in this way, may be disposed on the same line in the width direction of the first body 1020.

Here, the composite filter 12 may primarily filter raw water introduced through the first inlet hole 1520a to thus discharge the same through the first outlet hole 1520b, and secondarily filter purified water passed through the osmotic pressure filter 14 and then introduced through the second inlet hole 1520c to thus discharge the same through the second outlet hole 1520d.

In addition, the osmotic pressure filter 14 may filter purified water introduced into the third inlet hole 1540a and supply the same to the flushing tank 30 or the composite filter 12 through the third outlet hole 1540b.

Here, when the user operates the water purifier, the pump 20 may be operated for raw water introduced into the water purifier 1 to pass through each of the flow paths, the composite filter 12, and the osmotic pressure filter 14.

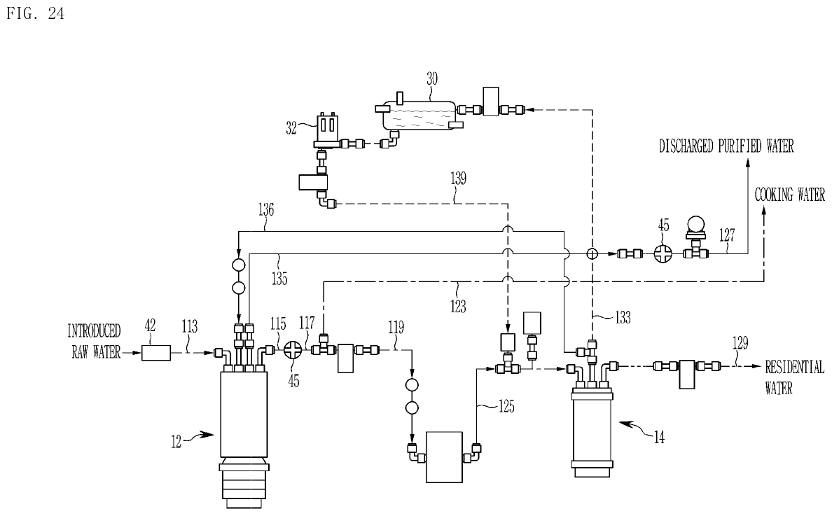

The description describes a flow of raw water or purified water in the flow path assembly 1000 for a water purifier configured as described above with reference to FIG. 24.

FIG. 24 is a view of the flow in the flow path and shows the flows of raw water and purified water in a water purifier to which the flow path assembly for a water purifier according to the second embodiment of the present disclosure is applied.

First, when the user operates the water purifier 1, raw water supplied from the raw water supply source may be introduced into the first flow path part 1120 by the operation of the pump 20.

Here, raw water introduced into the first flow path part 1120 may flow to the first flow path 1130 while having a reduced pressure by an operation of the pressure reduction valve 42, and may be introduced into the composite filter 12 through the first inlet hole 1520a communicating with the first flow path 1130.

Raw water introduced into the composite filter 12 may be filtered and purified while primarily passing through the composite filter 12, and purified water may be discharged through the first outlet hole 1520b and introduced into the second flow path 1150 of the second flow path part 1140.

Purified water introduced into the second flow path 1150 may be introduced into the third flow path 1170 of the third flow path part 1160 through the flow rate sensor 45 mounted on the second flow path part 1140 and the first bent part 1160a.

Purified water introduced into the third flow path 1170 may be introduced into the pump connection part 1180b by the operation of the solenoid valve 44 mounted on the second bent part 1160 and the third bent part 118b.

Purified water introduced into the pump connection part 1180b may pass through the pump 20, may be introduced into the osmotic pressure filter 14 through the third inlet hole 1540a which communicates with the sixth flow path 1250 of the sixth flow path part 1240, and may be filtered and purified while passing through the osmotic pressure filter 14.

Among purified water passed through the osmotic pressure filter 14, some purified water discharged through the third outlet hole 1540b may flow to the ninth flow path 1330 of the ninth flow path part 1320, and may be introduced into the flushing tank 30 by the operation of the solenoid valve 44 mounted on the tank connection part 1320c and the tank mounting part 1420.

Meanwhile, remaining purified water discharged through the third outlet hole 1540b may be introduced into the eleventh flow path 1370 of the eleventh flow path part 1360 communicating with the ninth flow path 1330, and secondly introduced to the composite filter 12 through the second inlet hole 1520c communicating with the eleventh flow path 1360.

In addition, among purified water passed through the osmotic pressure filter 14, some purified water may be introduced into the eighth flow path 1290 of the eighth flow path part 1280 through the residential water outlet hole 1540c based on the user's operation, and may be discharged to the residential water discharge part 1280c.

Meanwhile, purified water introduced into the flushing tank 30 may be stored in the flushing tank 30, and introduced into the twelfth flow path 1390 of the twelfth flow path part 1380 by the selective operation of the flushing pump (not shown).

Purified water introduced into the twelfth flow path part 1380 may be introduced into the sixth flow path 1250 of the sixth flow path part 1240 by the operation of the solenoid valve 44, and the above-described process may be repeated.

Purified water filtered and purified again while secondarily passing through the composite filter 12 may be discharged to the tenth flow path 1350 of the tenth flow path part 1340 through the second outlet hole 1540d, and introduced into the seventh flow path 1270 of the seventh flow path part 1260 connected with the tenth flow path 1350 through the flow rate sensor 45.

Purified water introduced through the seventh flow path 1270 may be supplied to the user in a completed state based on the user's operation.

Meanwhile, the description describes an embodiment in which the water purifier 1, to which the flow path assembly 1000 for a water purifier according to the second embodiment of the present disclosure is applied, filters and purifies introduced raw water. However, the present disclosure is not limited thereto, and devices for cooling or heating purified water to supply cold water or hot water may be disposed in the water purifier 1 to meet the user's need.

In addition, the description describes an embodiment in which the flow path assembly 1000 for a water purifier according to the second embodiment of the present disclosure is applied to the direct-type water purifier 1 that filters and purifies introduced raw water and supplies the same directly to the user. However, the present disclosure is not limited thereto, and the assembly 1000 may also be applied to a storage-type water purifier that filters, purifies and stores introduced raw water and then supplies stored purified water to the user.

In addition, the description describes the water purifier to which the flow path assembly 1000 according to the second embodiment of the present disclosure is applied is an under-sink type water purifier installed in the sink, and the introduction of raw water and the discharges of purified water, residential water, and cooking water are each connected to the pipes. However, the present disclosure is not limited thereto.

That is, the flow path assembly 1000 according to the second embodiment of the present disclosure may be applied to a general water purifier exposed to the outside, rather than the under-sink type. In this case, a faucet for discharging purified water, residential water, and cooking water directly from the water purifier may be mounted on a part where purified water, residential water, and cooking water are discharged, by the user's operation.

Therefore, when applying the flow path assembly 1000 for a water purifier according to the second embodiment of the present disclosure configured as described above, it is possible to easily mount the various parts, the composite filter 12, and the osmotic pressure filter 14 therein, while integrating the flow paths which are the movement paths of introduced raw water with each other.

In addition, the second embodiment of the present disclosure may minimize the usage of pipes by applying the first to twelfth flow path parts 1120, 1140, 1160, 1180, 1220, 1240, 1260, 1280, 1320, 1340, 1360, and 1380, that is, the plurality of flow path parts integrated with each other without a fusion work, and simultaneously have improved workability while shortening the assembly and replacement time of the composite filter 12, the osmotic pressure filter 14 and each part by securing an internal space.

In addition, the second embodiment of the present disclosure may improve maintainability by easily assembling and disassembling each component and the various parts, reduce a production cost by reducing the overall number of parts, and improve productivity.

In addition, the second embodiment of the present disclosure may minimize occurrence of a product defect by improving airtightness by preventing leakage or damage due to a pressure of raw water, and reduce an overall size of the water purifier by promoting a smaller size, thereby improving overall marketability.

Although the present disclosure has been described in relation to the preferred embodiments described above, the present disclosure is not limited thereto. Various corrections or modifications may be made by those skilled in the art to which the present disclosure pertains without departing from the spirit and scope of the present disclosure and an equivalent scope of the appended claims.

1. A flow path assembly for a water purifier, the assembly comprising:
a main body;
one or more flow path parts each having a flow path through which raw water or purified water flows therein, and protruding from one surface of the main body for one or more parts to be mounted thereon; and
one or more filter mounting parts formed on the other surface of the main body to be opposite to the one or more flow path parts for at least one filter filtering raw water introduced through one flow path part among the one or more flow path parts to be mounted thereon,
wherein among the flow paths respectively formed in the one or more flow path parts, the flow paths disposed to correspond to the one or more filter mounting parts pass through the main body to be connected to the one or more filter mounting parts for raw water to be filtered and purified through the at least one filter, and
the other flow paths are each selectively connected with each other through the one part mounted on the one or more flow path parts.

2. The assembly of claim 1, wherein
the one or more flow path parts include
a first flow path part having a first flow path formed in a vertical direction parallel to the main body based on a length direction of the main body,
a second flow path part disposed to be spaced apart from the first flow path part in a width direction of the main body, bent toward a lower part of the main body while protruding by a predetermined length from the main body, and having a second flow path formed therein,
a third flow path part disposed at a lower part of the second flow path part, and having a third flow path formed in a direction perpendicular to the second flow path,
a fourth flow path part disposed at a lower part of the third flow path part, and having a fourth flow path formed in a direction parallel to the third flow path, and
a fifth flow path part disposed on an upper part of the main body that is opposite to the first flow path part based on the width direction of the main body, and having a fifth flow path formed in a vertical direction parallel to the first flow path.

3. The assembly of claim 2, wherein
the third flow path part includes
a connection part formed on the third flow path part at a position corresponding to the second flow path part for purified water flowing into the second flow path to pass through the third flow path, and connected to the second flow path through the one or more parts, and
a bent part having an end disposed to be adjacent to the first flow path part and bent from one surface of the main body toward the outside

4. The assembly of claim 3, wherein
the fourth flow path part includes
a protrusion protruding toward the outside from the one surface of the main body to correspond to the bent part to connect the third flow path with the fourth flow path through the one or more parts, and
a pump connection part having an end facing the first flow path part and bent toward the lower part of the main body, and connected to a pump through the one or more parts.

5. The assembly of claim 2, wherein
the fifth flow path part has
a tank connection part integrated with the fifth flow path part that protrudes in a center of the fifth flow path part based on a length direction of the fifth flow path part in a direction perpendicular to the fifth flow path part to be connected to a flushing tank for purified water stored in the flushing tank to be selectively introduced into the fifth flow path.

6. The assembly of claim 2, wherein
the one or more flow path parts include
a sixth flow path part disposed to be spaced apart from the fifth flow path part toward the first flow path part based on the width direction of the main body, and having a sixth flow path formed in a direction parallel to the fifth flow path,
a seventh flow path part disposed between the fifth flow path part and the sixth flow path part, and having a seventh flow path formed in a direction parallel to the sixth flow path,
an eighth flow path part disposed between the first flow path part and the sixth flow path part, and having an eighth flow path formed in the vertical direction parallel to the first flow path,
a ninth flow path part disposed between the first flow path part and the second flow path part to be close to the first flow path part, and having a ninth flow path formed in a direction perpendicular to the first flow path, and
a tenth flow path part disposed between the ninth flow path part and the second flow path part based on the width direction of the main body, and having a tenth flow path formed in a direction parallel to the first flow path.

7. The assembly of claim 6, wherein
the sixth flow path part further includes
a first flow path connection part protruding from a lower part based on a length direction of the sixth flow path part in a direction perpendicular to the sixth flow path part to connect the ninth flow path with the sixth flow path through the one or more parts.

8. The assembly of claim 6, wherein
the seventh flow path part further includes
a residential water discharge part protruding from an upper part based on a length direction of the seventh flow path part in a direction perpendicular to the seventh flow path part for purified water flowing through the seventh flow path to be discharged as residential water through the one or more parts.

9. The assembly of claim 6, wherein
the eighth flow path part further includes
a second flow path connection part protruding from a lower part based on a length direction of the eighth flow path part in a direction perpendicular to the eighth flow path part to connect the eighth flow path with the tenth flow path through the one or more parts.

10. The assembly of claim 2, wherein
the second flow path part is bent
into an “L” shape to partially surround the outside of the third flow path part.

11. The assembly of claim 6, wherein
the first, second, third, fourth, fifth, sixth, seventh, eighth, ninth, and tenth flow paths are
formed in the main body not to communicate with each other, or to be selectively connected with each other through the one or more parts or the one or more filters.

12. The assembly of claim 6, wherein
the filter mounting part includes
a first filter mounting part formed on a lower part of the other surface of the main body, and
a second filter mounting part formed on the other surface of the main body to be spaced upward from the first filter mount.

13. The assembly of claim 12, wherein
the first filter mounting part includes
a first inlet hole communicating with the first flow path,
a first outlet hole communicating with the second flow path,
a second inlet hole communicating with the tenth flow path, and
a second outlet hole communicating with the ninth flow path.

14. The assembly of claim 13, wherein
the first and second inlet holes and the first and second outlet holes are
disposed on the same line in the width direction of the main body.

15. The assembly of claim 13, wherein
the first inlet hole and the first outlet hole are respectively disposed on both sides of the main body based on the width direction of the main body,
the second inlet hole is disposed between the first inlet hole and the first outlet hole to be close to the first outlet hole, and
the second outlet hole is disposed between the first inlet hole and the first outlet hole to be close to the first inlet hole.

16. The assembly of claim 13, wherein
the second filter mounting part includes
a third inlet hole communicating with the fifth flow path,
a third outlet hole communicating with the eighth flow path, and
a residential water outlet hole communicating with the seventh flow path.

17. The assembly of claim 16, wherein
the third inlet hole, the third outlet hole, and the residential water outlet hole are
disposed on the same line in the width direction of the main body.

18. A flow path assembly for a water purifier, the assembly comprising:
a first body and a second body configured to be separated from each other to be coupled with each other;
one or more flow path parts each having a flow path through which raw water or purified water flows therein, and protruding from one surface or the other surface of each of the first and second bodies for one or more parts to be mounted thereon; and
one or more filter mounting parts formed on the other surface of each of the first and second bodies to be opposite to the one or more flow path parts for at least one filter filtering raw water introduced through one flow path part among the one or more flow path parts to be mounted thereon,
wherein among the one or more flow path parts, the one or more flow path parts formed at corresponding positions on one surface or the other surface of each of the first body and the second body are connected with each other directly or through the one or more parts in a state where the first body and the second body are coupled with each other,
among the flow paths respectively formed in the one or more flow path parts, the flow paths respectively disposed to correspond to the one or more filter mounting parts pass through the first body or the second body to be connected to the one or more filter mounting parts for raw water to be purified water through the at least one filter, and
the other flow paths are selectively connected with each other, respectively, through the one or more flow path parts directly connected thereto or through the one or more parts mounted on the one or more flow path parts.

19. The assembly of claim 18, wherein
the one or more flow path parts include
a first flow path part formed on the one surface of each of the first and second bodies, and having a first flow path formed in the vertical direction parallel to the first and second bodies along length directions of the first and second bodies,
a second flow path part disposed to be spaced apart from the first flow path part in a width direction of the second body, protruding by a predetermined length from the one surface of the second body, and having a second flow path formed therein,
a third flow path part disposed at a lower part of the second flow path part on the one surface of the second body, having both ends protruding from the one surface of the second body based on the width direction of the second body, and having a third flow path formed therein,
a fourth flow path part disposed at a lower part of a first lower flow path part on the one surface of the second body, and having a fourth flow path formed in a vertical direction parallel to a first lower flow path part,
a fifth flow path part formed on the other surface of each of the first and second bodies to be close to the first flow path part based on the width directions of the first and second bodies, and having a fifth flow path formed in a vertical direction parallel to the first flow path, and
a sixth flow path part disposed to be spaced apart from and opposite to the first flow path part based on the width direction of the first body, and having a sixth flow path formed in a direction parallel to the fifth flow path.

20. The assembly of claim 19, wherein
the one or more flow path parts further includes
a seventh flow path part formed on the one surface of each of the first and second bodies to be close to the fifth flow path part based on the width directions of the first and second bodies, and having a seventh flow path formed in the vertical direction parallel to the first flow path,
an eighth flow path part formed on the one surface of each of the first and second bodies between the sixth flow path part and the seventh flow path part to be close to the sixth flow path part, and having an eighth flow path formed in the vertical direction parallel to the first flow path,
a ninth flow path part formed on the one surface of each of the first and second bodies between the seventh flow path part and the eighth flow path part, and having a ninth flow path formed in the vertical direction parallel to the first flow path,
a tenth flow path part disposed at a lower part of the seventh flow path part on one surface of the second body, and having a tenth flow path formed in a direction perpendicular to the first flow path,
an eleventh flow path part formed at a position corresponding to the ninth flow path part on the other surface of the second body, and having an eleventh flow path formed in the direction perpendicular to the first flow path, and
a twelfth flow path part disposed to be spaced apart from the one surface of the second body to be opposite to the fourth flow path part based on the width direction of the second body, and having a twelfth flow path formed in a vertical direction parallel to the first flow path.
